(19) United States
(12) Patent Application Publication
(10) Pub. No.: US 2009/0185138 A1
(43) Pub. Date: Jul. 23, 2009

(54) PROJECT-TYPE THREE-DIMENSIONAL IMAGE REPRODUCING APPARATUS

(75) Inventor: Takashi KUBARA, Fukuoka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/353,579

(22) Filed: Jan. 14, 2009

(30) Foreign Application Priority Data
Jan. 17, 2008 (JP) P2008-007713

(51) Int. Cl. G02B 27/26

(52) U.S. Cl. 353/8; 359/463

(57) ABSTRACT

The present invention provides a projection-type three-dimensional image reproducing apparatus that enables stable provision of a three-dimensional image display by preventing occurrence of crosstalk between adjacent lenses or adjacent hologram optical elements and eliminating shift of a three-dimensional image when a steroscopic image is reproduced by use of a lenticular lens array, a fly-eye lens array, or a hologram optical element. The three-dimension image reproduce apparatus includes an array of adjoining optical elements, which is an array of lenticular lens, a fly-eye lens array or an array of hologram optical elements, and a cross-talk prevent part preventing cross-talk between the adjoining optical elements.

### BACKGROUND OF THE INVENTION

The present invention relates to a three-dimensional image reproducing apparatus that reproduces a stereographic image by use of a lenticular lens array, a fly-eye lens array, or a hologram optical element.

A parallel-vision random dot stereogram method under which a right-side stereographic image including binocular parallax is viewed with a right eye and which a left-side stereographic image including binocular parallax is viewed with a left eye, a stereoscope method under which a view is acquired by use of eyeglasses with a liquid-crystal shutter or by using one lens for a right eye and another lens for a left eye, and an anaglyph method under which a red binocular parallax picture and a blue binocular parallax picture, both of which differ from each other in only color, are viewed by use of red-and-blue eyeglasses, and other methods, have been known as methods for displaying three-dimensional image information since old times. However, when a three-dimensional image is viewed under these methods, special training or special eyeglasses are necessary.

By virtue of development of a liquid crystal technique, liquid crystal displays providing a three-dimensional display without eyeglasses are recently released one after another. Most of the displays are three-dimensional liquid crystal displays of image splitter type without eyeglasses. Specifically, the three-dimensional liquid crystal display without eyeglasses produces three-dimensional effect by periodically arranging the image optical paths toward the liquid crystal display to right and left eye of an observer. That is, such display divides and periodically arranges the horizontally adjacent pixels of liquid crystal display to right and left eye of an observer by a parallax barrier or a lenticullar lens and the like.

Thus, the three-dimensional liquid crystal display device without eyeglasses is a three-dimensional image display device having only horizontal parallax. Images supplied to the positions of the left and right eyes of the observer include horizontal parallax attributable to the parallax barrier or the lenticular lens array. Hence, the display device in principle involves a problem of loss of a stereoscopic effect when the positions of the right and left eyes of the observer deviate from the horizontal direction.

Therefore, in a three-dimensional image display device including a combination of a liquid crystal display panel and a parallax barrier or a lenticular lens array, if an attempt is made to acquire stereoscopic vision with a steroscopic effect of a three-dimensional movies or pictures for a long period of time, it is necessary to spatially fix the positions of the right and left eyes in place.

In relation to horizontal deviation in the positions of the right and left eyes, the method for correcting and controlling the image optical paths in accordance with the deviation by monitoring the position of eyes and/or face of an observer by a sensor. However, the method entails a large-scale apparatus and inconvenience of equiping an observer with a marker to sense the positions of eyes and the position of a face.

As a method enables to provide a three-dimensional display of image independent from the position of eyes, the method which is extension of integral photography method after M. G. Lippmann in 1908 has been proposed. This proposed three-dimensional display method uses a two-dimensional display panel such as liquid crystal display substituting for a film, a pin hole and fly-eye lens array (a fly-eye shaped convex lens array). This method is, for example, described in JP-2001-275134.

The above mentioned integral photography proposed by M. G. Lippmann reproduces a three-dimensional image by following method. At first, a film is placed at the position of a focal point of the fly-eye lens array. Then images of respective convex lenses (fly-eye lenses) of the fly-eye lens array are recorded on the film. During reproducing operation, the images from the respective convex lenses of the fly-eye lens array recorded on the film is reproduced by passing the images through the same fly-eye lens array as that used in recording the images on the film in the opposite direction.

Incidentally, an optical structure required to perform stereogram with naked eye includes an image splitter method, a lenticular method, and integral photography.

Under the image splitter method, in order to display a left-eye image at the position of the left eye and a right-eye image at the position of the right eye, optical slits are provided so as to prevent the left eye from viewing the image for right-eye and the right eye from viewing the image for left-eye. Further, under the lenticular method, the right-eye image and the left-eye image are arranged in the form of a strip by means of respective convex lenses (semicylindrical cylindrical lenses) of the lenticular lens array, and the positions of images are set according to an image-forming equation (1/f=1/a+1/b). Under integral photography, an image including a plurality of parallaxes is positioned below a lenticular lens array, a fly-eye lens array, and a pin hole and rendered so as to project the image in a parallax direction.

However, the optical configuration required to perform conventional stereograph with naked eye has a problem of cross-talk between lenses. When the eyes of an observer laterally move from observation position, the parallax image can be seen at some level. However, when movement of the eyes exceeds a certain area, a parallax image of the adjacent lens is observed. This fact causes the cross-talk between lenses.

When crosstalk arises between lenses, an image to be originally displayed by the next lens or slit is displayed; hence, an image becomes distorted or shifted. For this reason, crosstalk greatly affects quality of a stereoscopic display.

As a countermeasure against the problem, an attempt has been made to geometrically make it difficult to form an image of display data from the next lens by use of a lens having a short focal length, to thus diminish the crosstalk. In order to achieve a short focal length in an optical system having a simple structure, a reduction in the curvature radius of a lens is effective. However, it is very difficult to efficiently manufacture a lens array having a small curvature radius.

Another attempt is also made to optically insulate lenses one from another by use of a shield mask. However, there arises a problem of a reproduced three-dimensional image becoming dark and three-dimensional reproduction being hindered by a contour effect of the shield mask. The same also applies to a case where a stereoscopic image is reproduced by use of a hologram optical element.

### SUMMARY OF THE INVENTION

The present invention has been conceived in light of the above problems and aims at providing a projection-type three-dimensional image reproducing apparatus that enables stable provision of a three-dimensional image display by preventing occurrence of crosstalk between adjacent lenses or adjacent hologram optical elements and eliminating shift of a three-dimensional image when a steroscopic image is reproduced by use of a lenticular lens array, a fly-eye lens array, or a hologram optical element.

In order to achieve the foregoing object, the present invention provides a A three-dimension image reproduce apparatus includes an array of adjoining optical elements, which is an array of lenticular lens, a fly-eye lens array or an array of hologram optical elements, and a cross-stalk prevent part preventing cross-talk between the adjoining optical elements. The cross-talk prevent part includes at least one projector projecting a plurality of images each of which is separated into a strip shape and each of which has different parallax information so that each of the images has different polarization state from each other, in order that the ray from each of the images passes through the corresponding optical element, and a polarizing plate provided on an emitting side of the optical elements and having a polarized character which is different on the adjoining optical elements and same on the next adjoining optical elements.

Preferably, the polarization states are transverse polarization and longitudinal polarization. In stead, left-circular polarization and right circular polarization are also preferable.

Preferably, the projector controls the polarization state of each of the images by a polarization filter. In case the number of the projector is one, the projector controls the polarization state of each of the images by a polarization filter with polarization switch.

According to the present invention, occurrence of crosstalk between adjacent lenses or adjacent hologram optical elements can be prevented. Thus, an image that should not originally be displayed is not displayed on the adjacent lens or the adjacent hologram optical element. As a consequence, distortion or shift of an image is prevented. Therefore, there is yielded an advantage of the ability to implement a three-dimensional image reproducing apparatus capable of providing a stable stereoscopic image, enhanced image quality of a three-dimensional image display, and an enhanced stereoscopic effect.

### BRIEF DESCRIPTION OF THE DRAWINGS

FIG. 1 is a view showing a system configuration of an optical system serving as the principal unit of a three-dimensional image reproducing apparatus of an embodiment of the present invention.

FIG. 2 is a view for describing the principle of integral photography.

FIG. 3 is a view for describing crosstalk from an adjacent lens in the lenticular lens array.

FIG. 4 is a view for describing an image configuration in which different polarized images projected by two projectors shown in FIG. 1 are combined together and projected.

FIG. 5 is a view for describing the principle of operation for displaying a crosstalk-free image on a target lenticular lens in the projection-type three-dimensional image reproducing apparatus shown in FIG. 1.

### DETAIL DESCRIPTION OF PREFERRED EMBODIMENT

The present invention can be applied to a display method, such as integral photography, a lenticular method, a parallax barrier method, and an ultra-multiple lens method, and the like, which enables provision of stereogram display with naked eye by combination of two-dimensional image information including parallax information, a lenticular lens array, a slit-shaped barrier such as liquid crystal, and a fly-eye lens or a hologram optical element. A preferred embodiment of a projection-type three-dimensional image reproducing apparatus of the present invention will be described hereunder in detail by reference to the drawings. Respective embodiments illustrate the case of use of a lens array. However, the same also applies to the case of use of a hologram optical element.

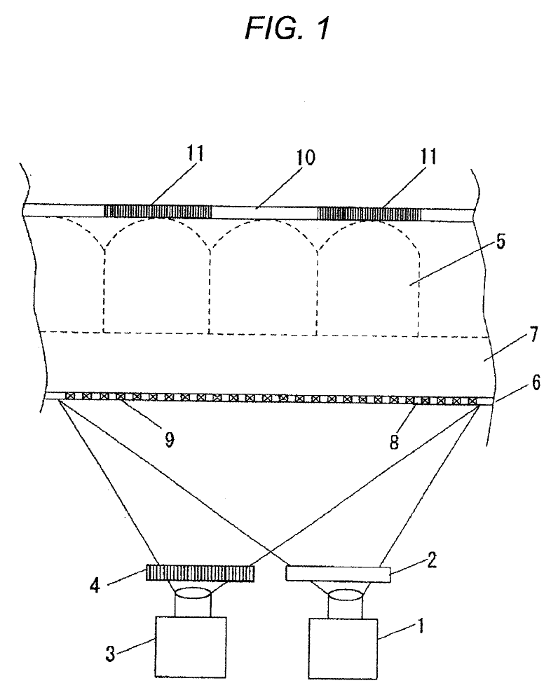

FIG. 1 is a view showing a system configuration of an optical system that is the principal part of a projection-type three-dimensional image reproducing device of an embodiment of the present invention.

As shown in FIG. 1, in the present embodiment, there is shown an example for displaying a two-dimensional image including parallax information by use of two projectors; namely, a lateral polarization projector 1 and a longitudinal polarization projector 3. The number of projectors is not limited to two, and a plurality of projectors exceeding two can also be used. Alternately, one projector can also be used. In this case, it would be better to additionally provide a mechanism for changing polarization conditions by use of a polarizing filter equipped with a polarization switch, thereby enabling control of a state of polarization of an image to be projected.

In FIG. 1, the right lateral polarization projector 1 is additionally provided with a lateral polarization filter 2, and the left longitudinal polarization projector 3 is provided with a longitudinally polarization filter 4. Thereby, images projected by the respective projectors form a two-dimensional image including parallax information on a screen 6 spaced from the lens array 5 by a focal length. Consequently, an image formed on the screen 6 includes images 8 generated by laterally-polarized light and images 9 generated by longitudinally-polarized light.

Since the screen 6 is disposed at the position of a focal length of the lens array 5, a spacer 7 can also be interposed between the lens 5 and the screen 6.

The image including the images 8 generated by laterally-polarized light on the screen 6 and the images 9 generated by longitudinally-polarized light is reproduced as a three dimensional image through the spacer 7 and the lens array 5. In this embodiment, lateral polarizing plates and longitudinal polarizing plates are provided on each lens surface of the lens array 5 alternately in order to project the image 8 and the image 9 from the lens array without crosstalk.

The present embodiment shows a case where a lenticular lens array is used as a lens array 5. However, a fly-eye lens array (a fly-eye lens array) can also be used.

Polymethylmethacrylate that is used for a common plastic lens and that is so-called an acrylic resin, PET that is so-called polyethylene terephthalate, an episulphide resin, and the like, can be used as a material for the lens array 5.

An acrylic resin, polyethylene terephthalate, an episulphide resin, and the like, can be used as a material for the spacer 7, as in the case with the lens array 5.

A hologram screen generated by a volume hologram or a translucent scattering screen can also be used as the screen 6 for forming a two-dimensional image including parallax information. Further, translucent glass can also be used. Alternately, a screen formed from liquid crystal, and the like, can also be used.

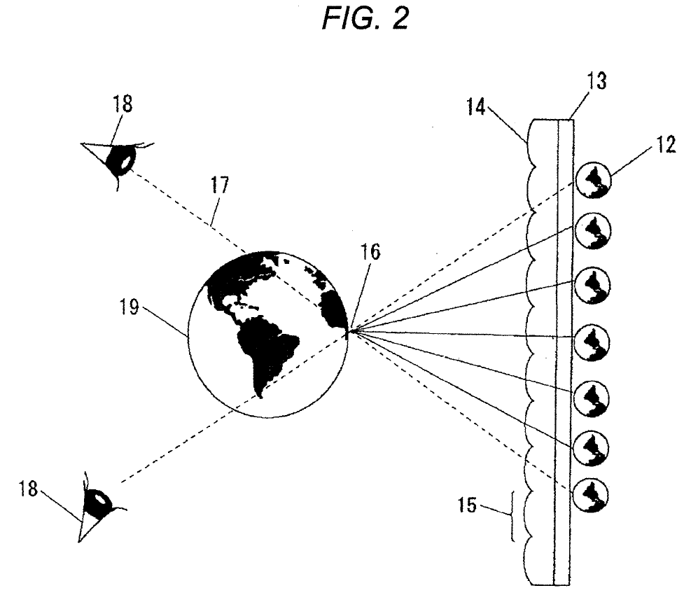

By reference to FIGS. 2 through 5, operation will be described hereunder. Integral photography described in JP-P-2001-275134 will first be described by reference to FIG. 2. FIG. 2 is a view for describing the principle of integral photography.

To begin with, integral photography proposed by M. G. Lippmann in 1908 is described.

In FIG. 2, a fly-eye lens array 14 is used for the integral photography proposed by M. G. Lippmann in 1908. The fly-eye lens array 14 is embodied by means of placing a plurality of small convex lenses (fly-eye lenses) 15 like a compound eye of the fly on a sheet substrate.

An unillustrated film is placed at the position of a plane side focal point of the fly-eye lens array 14. The film is exposed by an object light from the lens side of the fly-eye lens array 14 so that a small object image belonging to each of the convex lenses (a reproduced element image 12 in an illustrated embodiment) are registered on the film.

A developed film is again placed at the position of the focal point of the fly-eye lens array 14 and exposed to light from the back, to thus make an observation through the fly-eye lens array 14. Thereby, a stereoscopic image (a three-dimensional reproduced image 19 of an illustrated embodiment) is reproduced from the small subject images generated for the respective convex lenses 15 recorded on the film.

In short, under the integral photography described in JP2001-275134, a display element 13 is placed in lieu of the film at the position of the focal point generated on the plane surface side of the fly-eye lens array 14, the reproduced element images 12 belonging to the corresponding convex lenses 15 are displayed on the display element 13, and the thus-displayed images are observed from the lens side of the fly-eye lens array 14, as shown in FIG. 2. As a result, optical paths of the reproduced element images 12 displayed on the display element 13 converge on an image formation point 16 corresponding to the position of a pixel of a surface of the original image by way of the respective convex lenses 15. The optical path further takes divergent paths like rays 17 originating from the image formation point; and enter pupils 18 of the observer. Hence, the three-dimensional reproduced image 19 exhibiting a stereoscopic effect is reproduced.

In this case, the image formation point 16 is present in a levitating fashion. Hence, even when changing a view angle or positions of the eyes, the observer can stably view the three-dimensional reproduced image 19 exhibiting a stereoscopic effect.

In general, in the stereoscopic image method, the optical paths of the two-dimensional image including parallax information 3 are spatially separated and provided so that the image for the right-eye is seen from the right-eye position and the image for the left-eye is seen from the right-eye position. In order to produce a stereographical effect, the image for the right-eye and the image for the left-eye are divided into strips as many as the number of columns of the slits or the lenticular lenses. The strips of images are rearranged so that the strip of the image for the right-eye and the strip of the image for the left-eye are disposed alternately. Then the pair of the strips of the image for the right-eye and for the left-eye is allotted to one of the slits or the lenticular lenses.

Under the ultra-multiple eye method or the integral photography, images equal in number to parallaxes are divided into short strips equal in number of slits or lenticular lens arrays. Re-positioning the parallax images divided into short strips in sequence and in the parallax direction. The parallax images equal in number to the parallaxes are grouped as a set, and the set is assigned to one slit or one lenticular lens, whereby a stereoscopic image can be reproduced.

Three-dimensional image information comes into a three-dimensional stereoscopic image including a plurality of horizontal, vertical parallaxes when the image information enters the eyes of the observer. A two-dimensional image including parallax information assigned to one slit or one lenticular lens is usually assigned to a target slit or a target lenticular lens. When viewed from the front, a two-dimensional image that enters the slit or the lenticular lens and that includes parallax information enters the observer's eyes.

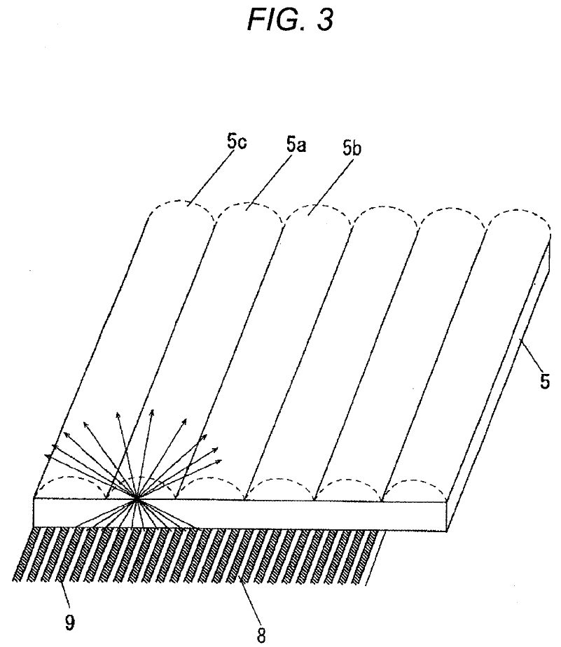

FIG. 3 is a view for describing crosstalk from an adjacent lens in the lenticular lens array. As shown in FIG. 3, when the lenticular lens array 5 is observed from a low depression angle, a two-dimensional image that is in proximity to a focal plane of an adjacent lenticular lens 5b, 5c and that includes parallax information enters a target lenticular lens 5a. Because the image enters the observer's eyes from the target lenticular lens 5a, crosstalk arises, and distortion or shift of an image is caused.

In order to prevent occurrence of such crosstalk, a device must be conceived to prevent images 8 and 9 including parallax information, which is to enter an adjacent lenticular lenses 5b, 5c and which are generated by longitudinally-polarized light and laterally-polarized light, from entering a target lenticular lens 5a.

However, in order to project image information from a target lenticular lens without entering the observer's eyes when observing the image from a small depression angle, it is necessary to physically project a parallax image of the low depression angle. This is, on first glance, antimony.

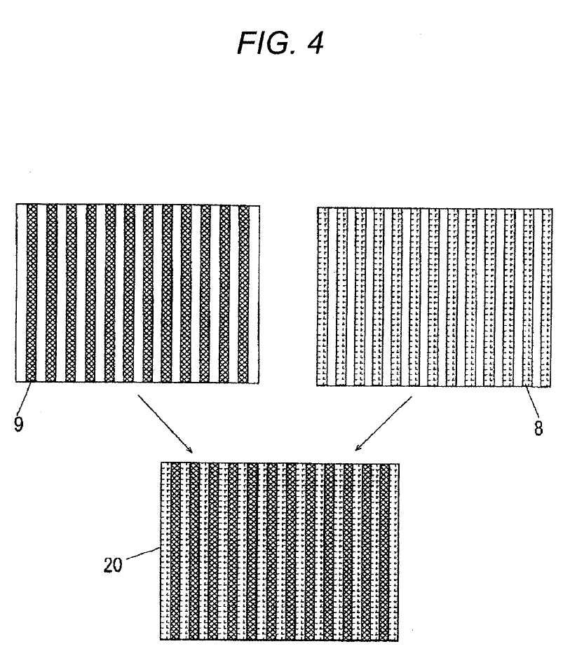

For this problem, in the present embodiment adopting a display of integral photography using projected images, projected images are first edited into strip shapes as shown in FIG. 4, and the images are configured such that respective pictures are arranged in a single staggered picture on a screen.

FIG. 4 is a view for describing an image structure in which different polarized images are superimposed and projected by two projectors shown in FIG. 1. In FIG. 4, the images projected by the longitudinal polarization projector 3 through the longitudinal polarization filter 4 are projected on the screen 6 as images 9 generated by longitudinally-polarized light. The image projected by the lateral polarization projector 1 through the lateral polarization filter 2 is projected on the screen 6 as the images 9 generated by longitudinally-polarized light. When the images are overlaid on the screen 6, two-dimensional images 20 that include parallax information and that are to be superimposed on a single screen are generated. The two-dimensional images 20 that are to be superimposed on the screen and that include parallax information are formed in the form of strips on respective lenticular lenses of the lenticular lens array 5. A similar advantage is yielded even when the polarizing filter is a right-handed circular polarization plate and a left-handed circular polarization plate.

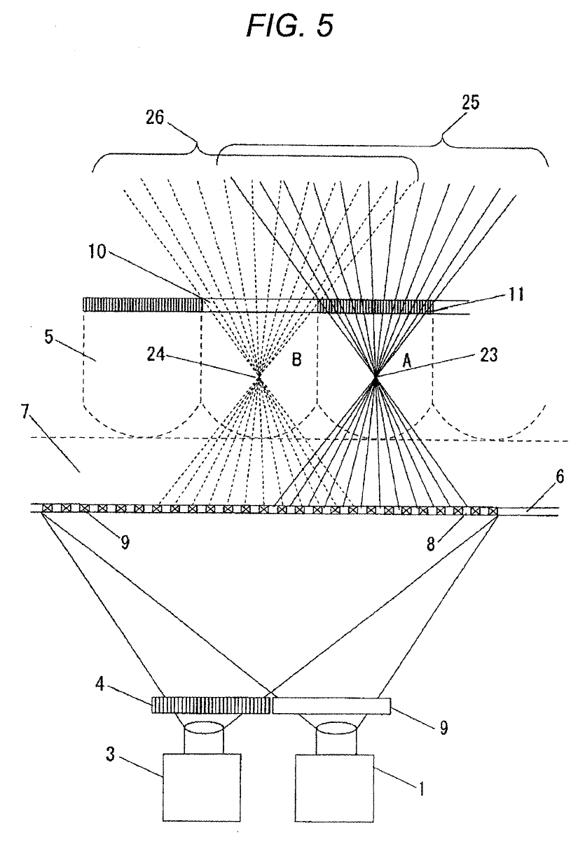

In this case, when the two-dimensional images 20 that are to be superimposed on a screen and that include parallax information are emitted from the respective lenticular lenses, a problem of crosstalk is not resolved. Hence, in the present embodiment, a polarizing filter is provided on an exit surface of the lenticular lens array 5, as well. By means of the method shown in FIG. 5, the problem of crosstalk is resolved.

FIG. 5 is a view for describing the principle of operation for displaying a crosstalk-free image on a target lenticular lens in the projection-type three-dimensional image reproducing apparatus shown in FIG. 1.

In FIG. 5, provided that pictures assigned to pixels arranged so as to differ from each other in terms of polarization are a picture A and a picture B, the picture A is assigned to a lenticular lens 23, and the picture B is assigned to a lenticular lens 24 in connection with the lenses 23 and 24 assigned the adjacent pictures A and B in the lenticular lens array 5. The longitudinal polarizing filter 11 is affixed to an exit end of the lens 23 assigned the picture A, and the lateral polarizing filter 10 is affixed to an exit end of the lens 24 assigned the picture B.

The two-dimensional image 20 including parallax information enters the input ends of the lens 23 assigned the picture A and the lens 24 assigned the picture B. The two-dimensional image 20 is the combination of the laterally-polarized image and the longitudinally-polarized image on the screen 6. In this case, since the longitudinal polarizing filter 11 is affixed to the exit end of the lens 23 assigned the picture A, a laterally-polarized image in the two-dimensional image 20 that is combined on the entrance screen and that includes parallax information cannot pass through the exit end of the lens 23 assigned with the picture A. A pixel image 25 of the picture A that can be observed at the exit end of the lens 23 assigned the picture A is merely a longitudinally-polarized image.

Likewise, since the lateral polarizing filter 10 is affixed to the exit end of the lens 24 assigned the picture B, a longitudinally-polarized image in the two-dimensional image 20 that is to be combined on an entrance screen and that includes parallax information cannot pass through the exit end of the lens 24 assigned the picture B. A pixel image 26 of the picture B that can be observed at the exit end of the lens 24 assigned the picture B is merely a laterally-polarized image.

As mentioned above, even when the observation region is set to a low depression angle, occurrence of crosstalk between the adjacent lenses 23 and 24 assigned the pictures A and 3 can be prevented. Thus, an image that should not be originally displayed is not displayed on the adjacent lenticular lens. As a consequence, occurrence of a phenomenon of distortion or shift of an image is prevented.

As mentioned above, according to the embodiment, occurrence of a crosstalk between lenses can be prevented. Hence, a stereoscopic image becomes stable, image quality of the three-dimensional image display is enhanced, and a three-dimensional image reproducing apparatus capable of enhancing a stereoscopic effect can be embodied.

As mentioned above, the projection-type three-dimensional image reproducing apparatus of the present invention is effective for realizing a stable three-dimensional image display when a stereoscopic image is reproduced by use of a lenticular lens array, a fly-eye lens array, or a hologram optical element, by preventing occurrence of crosstalk between adjacent lenses or adjacent hologram optical elements, to thus eliminate a shift of the three-dimensional image. In particular, the three-dimensional image reproducing apparatus is suitable for use in fields of imaging technology, amusement, entertainment, the Internet, information, multimedia, communication, advertisement, medical treatment, art, education, design support, simulation, virtual reality, and the like.

What is claimed is:

1. A three-dimension image reproduce apparatus comprising:
an array of adjoining optical elements, which is an array of lenticular lens, a fly-eye lens array or an array of hologram optical elements; and
a cross-talk prevent part preventing cross-talk between the adjoining optical elements.

2. The image reproduce apparatus according to claim 1, wherein the cross-talk prevent part comprises:
at least one projector projecting a plurality of images each of which is separated into a strip shape and each of which has different parallax information so that each of the images has different polarization state from each other, in order that the ray from each of the images passes through the corresponding optical element; and
a polarizing plate provided on an emitting side of the optical elements and having a polarized character which is different on the adjoining optical elements and same on the next adjoining optical elements.

3. The image reproduce apparatus according to claim 2, wherein the polarized characters are lateral and longitudinal polarization.

4. The image reproduce apparatus according to claim 2, wherein the polarized characters are right-circular and left-circular polarization.

5. The image reproduce apparatus according to claim 2, wherein the projector controls the polarization state of each of the images by a polarization filter.

6. The image reproduce apparatus according to claim 2, wherein the projector controls the polarization state of each of the images by a polarization filter with polarization switch, in case the number of the projector is one.
